(19) United States
(12) Patent Application Publication
(10) Pub. No.: US 2007/0239830 A1
(43) Pub. Date: Oct. 11, 2007

(54) METHOD AND APPARATUS FOR INSTANT MESSAGE NOTIFICATION AND FORWARDING

(76) Inventors: Thomas Henry Barnes, Austin, TX (US); John W. Dunsmoir, Round Rock, TX (US); Sheryl S. Kinstler, Dripping Springs, TX (US); Elizabeth Anne Wallace, Fishers, IN (US); Carol Sue Robertson Walton, Austin, TX (US)

Correspondence Address: IBM CORP (YA);C/O YEE & ASSOCIATES PC, P.O. BOX 802333, DALLAS, TX, 75380, US

(21) Appl. No.: 11/278,752

(22) Filed: Apr. 5, 2006

(51) Int. Cl. G06F 15/16

(52) U.S. Cl. 709/206

(57) ABSTRACT

A computer implemented method, apparatus, and computer usable program code for receiving an instant message to form a received message. A determination is made as to whether a response to the received message has occurred within a period of time. The received message is selectively forwarding to a set of destinations based on a policy if the response to the received message is absent after the period of time.

### BACKGROUND OF THE INVENTION

1. Field of the Invention

The present invention relates generally to an improved data processing system and in particular to a method and apparatus for processing data. Still more particularly, the present invention relates to a computer-implemented method, apparatus, and computer usable program code for processing messages.

2. Description of the Related Art

Instant messaging is an online chat medium, allowing users to communicate with each other and collaborate in real-time over a network data processing system. Instant messaging is commonly used over the Internet. Instant messaging applications monitor and report the status of users that have established each other as online contacts. This information is typically presented to a user in a window. Instant messaging applications also are often used by users conducting business. By utilizing instant messaging, business users can view each other's availability and initiate a text conversation with colleagues or customers when a desired contact becomes available.

Typically, with instant messaging applications, communications between users are initiated by users selecting the name of the person with whom they desire to communicate. Then, the users type messages in a dialog box in the window and press “send”. These messages appear instantly on the other selected recipient's computer.

Until now, instant messaging has been developed largely for home users, but used by home and business users alike. Instant messaging allows an organization to deploy and utilize this “need-to-have” technology in a business setting.

Instant messaging systems have become an integral part of work communications in managing efforts with remote employees across various locations. With instant messaging systems, users within an organization may reach each other “instantly” as compared to other types of messaging systems, such as email. This ability to quickly reach another user is hampered if the user is away from the user's computer. When this situation occurs, the user sees the message only when the user returns to the computer. Further, the sender of the message also has to wait for that user to return. In these instances, the use of instant messaging systems does not provide the ability to quickly communicate with another user.

### SUMMARY OF THE INVENTION

The present invention provides a computer implemented method, apparatus, and computer usable program code for receiving an instant message to form a received message. A determination is made as to whether a response to the received message has occurred within a period of time. The received message is selectively forwarded to a set of destinations based on a policy if the response to the received message is absent after the period of time.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which aspects of the present invention may be implemented;

FIG. 2 is a block diagram of a data processing system in which aspects of the present invention may be implemented;

FIG. 3 is a block diagram illustrating components used in an instant messaging system in accordance with an illustrative embodiment of the present invention;

FIG. 4 is a diagram illustrating components used in an instant messaging system in accordance with an illustrative embodiment of the present invention;

FIG. 5 is a flowchart of a process for forwarding instant messages in accordance with an illustrative embodiment of the present invention;

FIG. 6 is a flowchart of a process for executing a set of actions to forward a message in accordance with an illustrative embodiment of the present invention; and

FIG. 7 is a diagram illustrating pseudo-code for forwarding messages in accordance with an illustrative embodiment of the present invention.

### DETAILED DESCRIPTION OF THE PREFERRED EMBODIMENT

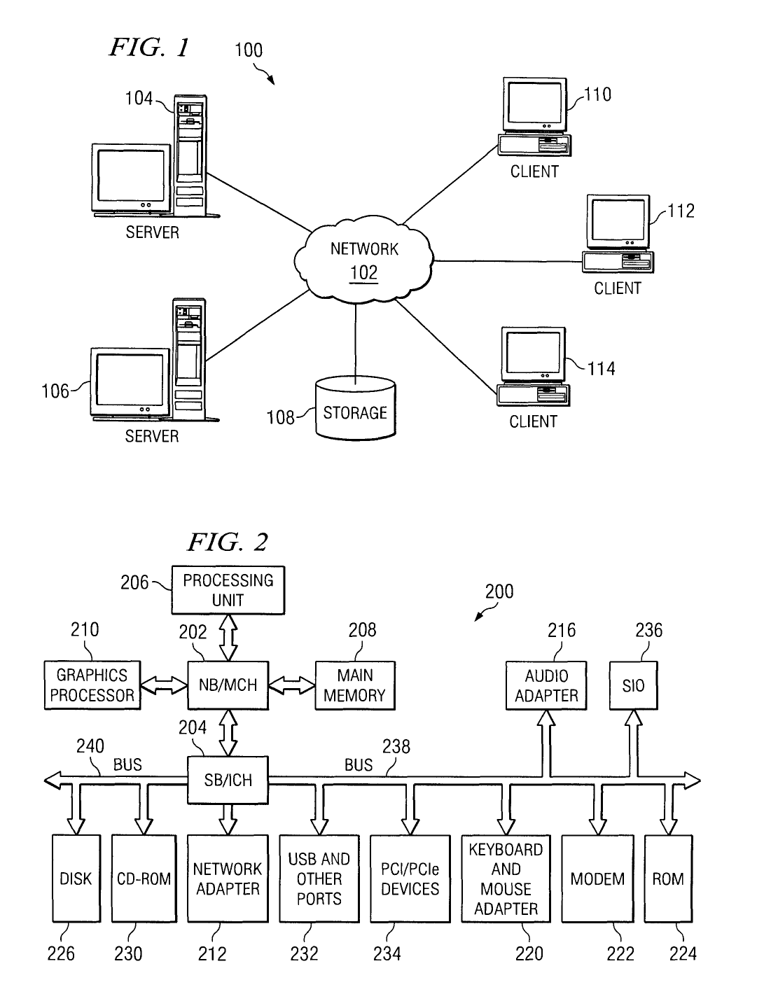

With reference now to the figures and in particular with reference to FIGS. 1-2, exemplary diagrams of data processing environments are provided in which embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of a network of data processing systems in which aspects of the present invention may be implemented. Network data processing system 100 is a network of computers in which embodiments of the present invention may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments of the present invention.

With reference now to FIG. 2, a block diagram of a data processing system is shown in which aspects of the present invention may be implemented. Data processing system 200 is an example of a computer, such as server 104 or client 110 in FIG. 1, in which computer usable code or instructions implementing the processes for embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206 and coordinates and provides control of various components within data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java programming system, may run in conjunction with the operating system and provides calls to the operating system from Java™ programs or applications executing on data processing system 200 (Java is a trademark of Sun Microsystems, Inc. in the United States, other countries, or both).

As a server, data processing system 200 may be, for example, an IBM® eServer™ pseries® computer system, running the Advanced Interactive Executive (AIX®) operating system or the LINUX® operating system (eServer, pseries and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for embodiments of the present invention are performed by processing unit 206 using computer usable program code, which may be located in a memory such as, for example, main memory 208, ROM 224, or in one or more peripheral devices 226 and 230.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

In some illustrative examples, data processing system 200 may be a personal digital assistant (PDA), which is configured with flash memory to provide non-volatile memory for storing operating system files and/or user-generated data.

A bus system may be comprised of one or more buses, such as bus 238 or bus 240 as shown in FIG. 2. Of course, the bus system may be implemented using any type of communication fabric or architecture that provides for a transfer of data between different components or devices attached to the fabric or architecture. A communication unit may include one or more devices used to transmit and receive data, such as modem 222 or network adapter 212 of FIG. 2. A memory may be, for example, main memory 208, ROM 224, or a cache such as found in NB/MCH 202 in FIG. 2. The depicted examples in FIGS. 1-2 and above-described examples are not meant to imply architectural limitations. For example, data processing system 200 also may be a tablet computer, laptop computer, or telephone device in addition to taking the form of a PDA.

The aspects of the present invention provide a computer-implemented method, apparatus, and computer usable program code for forwarding messages from an instant messaging client to another device. In this manner, a user is able to receive messages on a device, such as, for example, a telephone, a pager, a PDA, or a mobile phone. The manner in which a message may be forwarded is based on a policy. This policy contains a set of one or more rules that govern or define how and when messages received at an instant messaging client should be forwarded. The policy also may include parameters used in processing the rules. These parameters may include, for example, user preferences or default values. This policy allows for instant messages to be forwarded when the user is unavailable or not at the instant messaging client.

With the policy, a user may designate how to handle messages that have not been responded to by the user. For example, if a message is received at an instant messaging client and the recipient does not type text in response to the message within a period of time, instructions are executed to forward the message to that user at another device. The action to avoid forwarding also may include selecting the message for viewing. The user may enable or disable this particular feature. Typically, the user would enable this feature if the user is away from the user's station at which the instant messaging client is running.

Different options that may be defined in the policy include a time limit during which a response is required, how the message is to be forwarded, other actions that may be based on the identification of the sender, a number of attempts to forward the message, only notifying the user of the message, forwarding the limited number of characters or words from the message, or forwarding the entire message. The user may enable one of these options and set a time period after which the user is assumed to be away from the station. In this manner, the user is not required to remember to turn on and off the feature. In these examples, the different options are saved as part of the policy.

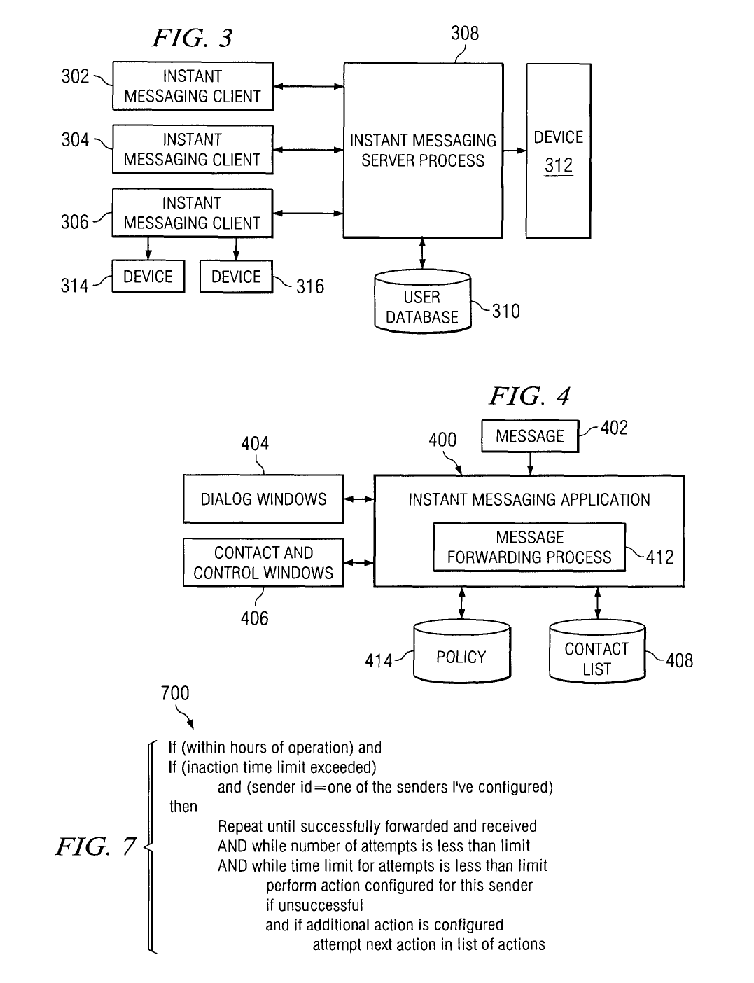

Turning now to FIG. 3, a block diagram illustrating components used in an instant messaging system in accordance with an illustrative embodiment of the present invention is shown. In this illustrative example, a user at instant messaging client 302 may send or exchange messages with other users at instant messaging clients 304 and 306. These instant messaging clients may be executing on a data processing system, such as data processing system 200 in FIG. 2. The exchange of messages in these examples is facilitated through instant messaging server process 308. This process allows for users to find other users within the instant messaging system as well as to aid in the exchange of messages between different users.

Depending on the particular instant messaging system, instant messaging server process 308 may only be involved in providing an indication of when particular users are online and for establishing initial contacts while users contacting users already on a buddy list may contact those users directly after seeing that a particular user is online. Instant messaging server process 308 may be located on a server, such as server 104 or 106 in FIG. 1.

In these examples, the different users registered to the instant messaging system are stored in user database 310. This user database provides information needed to search for and find other users as well as to contact users when they are online.

In this illustrative example, instant messaging client 306 may include a process for forwarding instant messages based on a policy. If the user does not type text in response to the message or select the message within a time limit, the process may selectively forward the message to another device, such as a computer or PDA. This other device may be, for example, another instant messaging client, such as instant messaging client 302. In this case, the user may be located at another computer. Alternatively, instant messaging client 306 may forward the received message to device 312 through instant messaging server process 308. Additionally, instant messaging client 306 may directly send the message without using instant messaging server process 308. For example, instant messaging client 306 may forward the message to device 314 or device 316.

Turning next to FIG. 4, a diagram illustrating components used in an instant messaging system is depicted in accordance with an illustrative embodiment of the present invention. The different components in FIG. 4 illustrate components that may be found in an instant messaging client, such as instant messaging client 306 in FIG. 3.

In the depicted example, instant messaging application 400 processes messages, such as message 402 received from users located on remote data processing systems. As messages are received, these messages are presented in dialog windows 404. Messages exchanged between instant messaging application 400 and an instant messaging application on a remote data processing system form a conversation in these examples.

Additionally, dialog windows 404 provide an interface for user input to send messages to other users. Contact and control windows 406 is presented by instant messaging application 400 to provide the user with a list of user names, as well as other information, such as, for example, identifying other users that are currently online. Contact and control windows 406 also provides an interface to allow the user to set different preferences. For example, the user may set passwords required to access different names used in instant messaging sessions. Further, a user may employ contact and control windows 406 to set other preferences, such as colors and fonts used in instant messaging application 400.

Further, the list of names presented by contact and control windows 406 is stored in contact list 408 in these examples. Additional user names may be added or deleted from contact list 408. This contact list is employed in presenting the list of names within contact and control windows 406. Additionally, the user may view the status of other users on contact and control windows 406. This status may be, for example, available or busy. When the status is available, instant messaging application 400 will accept messages from another instant messaging application to start a new conversation. When the status of another user is busy, messages from instant messaging application 400 are not accepted by the other application for that user.

In addition, instant messaging application 400 also contains message forwarding process 412 in these illustrative examples. This process is used to selectively forward instant messages received by instant messaging application 400. For example, message 402 may be forwarded by message forwarding process 412 to another device using policy 414. This device may be, for example, another data processing system on which another instant messaging application is executing. Alternatively, the device may be any device that may receive a notification of the receipt of an instant message. For example, these devices may include a mobile phone, a personal digital assistant, or a pager.

Policy 414 is used to determine when a message, such as message 402, received by instant messaging application 400, will be forwarded to another device. When an inactive time limit is exceeded, one or more actions are performed. In these examples, an inactive time limit is a period of time used to determine whether a received message should be forwarded to a set of one or more destinations. This inactive time limit is a period of time that may be used to set a timer. When the timer expires, if the user has not performed some selected action with respect to the received message, then another action may be initiated based on policy 414. These actions also are defined within policy 414. The actions may include, for example, selecting a device to which the message is to be forwarded.

Further, policy 414 may include a sender list. A sender list identifies which messages should be forwarded. This sender list may consist of one or more senders. Alternatively, the user may elect to forward messages sent from all senders. Individual sender actions may be defined within policy 414. For example, if a message is received from one individual, the message may be forwarded to one device, while a message received from another individual is forwarded to a different device.

Alternatively, the manner in which the message is forwarded may differ from sender to sender. For example, messages may be forwarded as a text message to another instant messaging client, a mobile phone, a personal digital assistant, or a pager. In another illustrative example, message forwarding process 412 may convert the text message into a voice message and forward this message to a telephone or mobile phone. Further, policy 414 may include operation hours. These operation hours may define times during which messages will be forwarded and times during which messages will not be forwarded.

Additionally, a message size limit may be defined within policy 414. If the message exceeds the size limit, only the characters up to the size limit are forwarded. Further, policy 414 may be used to select a preferential order of actions. With this type of configuration, the user may select to attempt to forward the message to a device until the message is successfully received. Alternatively, a limited number of tries may occur before the attempts are halted. Additionally, the user may select multiple devices for forwarding. In this type of configuration, a selected number of attempts will be made to forward the message to one device. If those attempts are unsuccessful, another device is selected for forwarding. In this manner, a user may first have a message forwarded to the user's personal digital assistant. If attempts to forward the message are unsuccessful, the message may then be forwarded to the user's mobile phone. Successful receipt of forwarded messages will be confirmed using device specific acknowledgement protocols.

The different actions described above for policy 414 are only intended as examples of different actions that may be taken based on the rules and parameters within policy 414. Of course, other types of actions may be set forth through policy 414 in addition to or in place of the ones described in these illustrative examples.

For example, if an instant message is not responded to within the time limit by placing the cursor in the reply window notification instructions in the profile can cause the receiving data processing system to generate audio sounds such as beeping, ringing or speaking the senders name repeatedly to alert the recipient of a new message. Further, based on forwarding instructions in the profile, the process may forward the message to another computer, or PDA or a phone (using text messaging or reading the text aloud via voice synthesizer).

The notification and forwarding instructions can be established for all senders (default), specific instant message sender Ids or groups of instant message sender Ids (similar to email distribution lists).

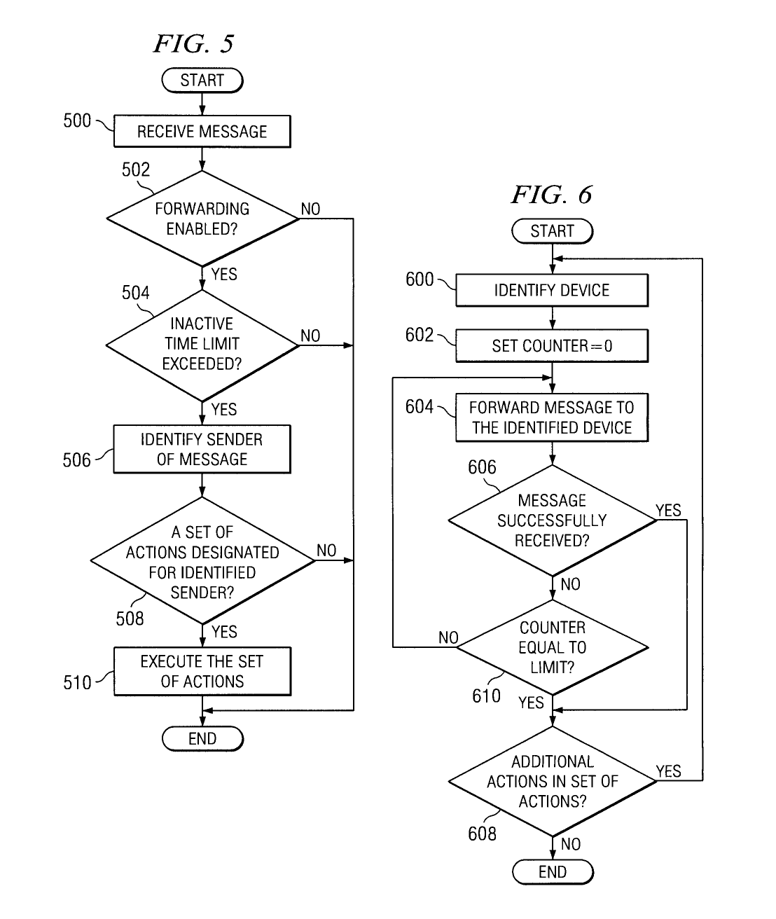

Turning now to FIG. 5, a flowchart of a process for forwarding instant messages is depicted in accordance with an illustrative embodiment of the present invention. The process illustrated in FIG. 5 may be implemented within an instant messaging client, such as instant messaging application 400 in FIG. 4. In particular, this process may be implemented within message forwarding process 412.

The process begins by receiving a message (step 500). Thereafter, a determination is made as to whether forwarding has been enabled (step 502). This determination is made by checking the policy to determine whether the message has been received during designated hours of operation. The policy is one, such as policy 414 in FIG. 4. If the message has been received during this time period, a determination is made as to whether an inactive time limit has been exceeded (step 504). This time limit also is defined within the policy. When the inactive time limit has been exceeded, the user is assumed to be unavailable or away from the instant messaging client. If the inactive time limit has been exceeded, the process identifies the sender of the message (step 506).

After the sender has been identified, a determination is made as to whether a set of actions has been designated for the identified sender (step 508). If a set of actions has been identified, the process executes the set of actions (step 510) with the process terminating thereafter. This set of actions may be one or more actions that are to be taken in handling the message.

With reference again to step 502, if forwarding is not enabled, the process terminates. In this case, the message has been received during a period of time in which messages are not to be forwarded. The process also terminates in step 504 if the inactive time limit has not been exceeded. In this case, the user has responded to the message by typing text in the screen for the message or selecting the message before the inactive time limit has been exceeded. With reference again to step 508, if a set of actions has not been designated for the identified sender, the process also terminates.

Turning now to FIG. 6, a flowchart of a process for executing a set of actions to forward a message is depicted in accordance with an illustrative embodiment of the present invention. The process illustrated in FIG. 6 is a more detailed illustration of step 510 in FIG. 5. The particular steps shown in FIG. 6 are intended as an example of one mechanism that may be used to execute a set of actions. Of course, other mechanisms or combinations of steps may be employed to execute the actions defined by the policy.

The process begins by identifying a device (step 600). This device is the device to which the message is to be forwarded. Next, the process sets a counter equal to zero (step 602). Thereafter, the process forwards the message to the identified device (step 604). A determination is then made as to whether the message has been successfully received by the device (step 606). If the message has been successfully received, a determination is made as to whether additional actions are present in the set of actions (step 608). If additional actions are not present, the process terminates. Otherwise, the process returns to step 600 as described above.

With reference again to step 606, if the message has not been successfully received, a determination is made as to whether the counter is equal to the limit for a number of attempts (step 610). In these examples, this limit is set by the policy. If the counter is not equal to the limit, the process returns to step 604. If the counter equals the limit, the process proceeds to step 608 as described above.

Turning next to FIG. 7, a diagram illustrating pseudo-code for forwarding messages is depicted in accordance with an illustrative embodiment of the present invention. In this example, code 700 is an example of pseudo-code that may be used to implement the forwarding process of the present invention.

Thus, the aspects of the present invention provide a computer-implemented method, apparatus, and computer usable program code for forwarding messages. When a message is received, a determination is made as to whether a response to the received message has occurred within a period of time. The message is selectively forwarded to a set of destinations based on the policy if the response to the received message is absent after the period of time. In this manner, faster notifications of messages occur in an instant messaging system.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for processing a message, the computer implemented method comprising:
receiving an instant message to form a received message;
determining if a response to the received message has occurred within a period of time; and
selectively forwarding the received message to a set of destinations based on a policy if the response to the received message is absent after the period of time.

2. The computer implemented method of claim 1, wherein the response is one of a user selection of the received message or a user input of text to respond to the received message.

3. The computer implemented method of claim 1, wherein the selectively forwarding step comprises:
sending the message to a selected device specified in the policy if the response to the received message is absent after the period of time.

4. The computer implemented method of claim 3, wherein the selected device is selected based on an identification of a user originating the received message.

5. The computer implemented method of claim 1, wherein the set of destinations comprises at least one of a mobile phone, a personal digital assistant, a pager, and another instant messaging program.

6. The computer implemented method of claim 5, wherein the policy specifies forwarding the message as one of a text message or a voice message to the set of destinations.

7. The computer implemented method of claim 1, wherein the selectively forwarding step comprises:
forwarding the received message to the set of destinations if the current time is within a selected time range.

8. The computer implemented method of claim 1, wherein the selectively forwarding step comprises:
sending the received message to a selected destination in the set of destinations;
determining whether the received message has been successfully sent to the selected destination;
responsive to an absence of a successful sending of the received message to the selected destination, selecting an unused destination from the set of selected destinations as the selected destination; and
responsive to selecting the unused destination, initiating the sending step.

9. The computer implemented method of claim 1, wherein the selectively forwarding step comprises:
sending only a portion of the received message to the set of destinations.

10. A computer program product comprising:
a computer usable medium having computer usable program code for processing a message, the computer program product comprising:
computer usable code for receiving an instant message to form a received message;
computer usable code for determining if a response to the received message has occurred within a period of time; and
computer usable code for selectively forwarding the received message to a set of destinations based on a policy if the response to the received message is absent after the period of time.

11. The computer program product of claim 10, wherein the response is one of a user selection of the received message or a user input of text to respond to the received message.

12. The computer program product of claim 10, wherein the computer usable program code for selectively forwarding the received message to a set of destinations based on a policy if the response to the received message is absent after the period of time comprises:
computer usable code for sending the message to a selected device specified in the policy if the response to the received message is absent after the period of time.

13. The computer program product of claim 12, wherein the selected device is selected based on an identification of a user originating the received message.

14. The computer program product of claim 10, wherein the set of destinations comprises at least one of a mobile phone, a personal digital assistant, a pager, and another instant messaging program.

15. The computer program product of claim 14, wherein the policy specifies forwarding the message as one of a text message or a voice message to the set of destinations.

16. The computer program product of claim 10, wherein the computer usable code for selectively forwarding the received message to a set of destinations based on a policy if the response to the received message is absent after the period of time comprises:
computer usable code for sending the received message to a selected destination in the set of destinations;
computer usable code for determining whether the received message has been successfully sent to the selected destination;
computer usable code for, responsive to an absence of a successful sending of the received message to the selected destination, selecting an unused destination from the set of selected destinations as the selected destination; and
computer usable code for, responsive to selecting the unused destination, initiating the sending step.

17. A data processing system comprising:
a bus;
a communications unit connected to the bus;
a memory connected to the bus, wherein the storage device includes computer usable program code; and
a processor unit connected to the bus, wherein the processor unit executes the computer usable program code to receive an instant message to form a received message; determine if a response to the received message has occurred within a period of time; and select forwarding the received message to a set of destinations based on a policy if the response to the received message is absent after the period of time.

18. The data processing system of claim 17, wherein the response is one of a user selection of the received message or a user input of text to respond to the received message.

19. The data processing system of claim 17, wherein the processor unit further executes the computer usable program code to send the message to a selected device specified in the policy if the response to the received message is absent after the period of time.

20. The data processing system of claim 19, wherein the selected device is selected based on an identification of a user originating the received message.
